(19) United States
(12) Patent Application Publication
(10) Pub. No.: US 2026/0149843 A1
(43) Pub. Date: May 28, 2026

(54) Automated Media Packaging, Validation, and Delivery System

(71) Applicant: Paulette Pantoja, Santa Clarita, CA (US)

(72) Inventor: Paulette Pantoja, Santa Clarita, CA (US)

(21) Appl. No.: 19/400,206

(22) Filed: Nov. 25, 2025

Related U.S. Application Data
(60) Provisional application No. 63/724,763, filed on Nov. 25, 2024.

(51) Int. Cl. H04N 21/25; G06F 21/60; H04N 21/2343

(52) U.S. Cl. CPC H04N 21/25; G06F 21/606; H04N 21/234309

(57) ABSTRACT

The present disclosure relates to a cloud-based system designed to automate the packaging, validation, processing, and delivery of media content and its supporting items. The system processes video, audio, subtitles, artwork, and metadata according to predefined specifications, ensuring compliance with technical and qualitative requirements for various endpoints. The system performs validation, error correction, transcoding, file conversion, and packaging based on saved profiles or templates. By leveraging cloud-based workflows and optional human oversight, the system ensures efficient and accurate delivery of media content to any destination.

### PRIORITY CLAIM

This application claims priority to provisional application Ser. No. 63/724,763 filed Nov. 25, 2024.

### FIELD OF THE INVENTION

This invention pertains to the field of digital media processing, focusing on automating the validation, processing, and delivery of media content and supporting items to meet predefined specifications. The invention is adaptable to various types of endpoints, ensuring compliance with diverse technical and quality standards.

### BACKGROUND OF THE INVENTION

The distribution of media content to multiple destinations requires adherence to complex and varied specifications, including format, resolution, metadata, and packaging requirements.

Current workflows rely heavily on manual processes for validation, transcoding, and delivery, which are prone to errors, inefficiencies, and increased operational costs.

There is a growing need for an automated system that can validate, process, and deliver media content while ensuring accuracy and compliance. Such a system would reduce errors, streamline operations, and scale effectively for large volumes of media.

### SUMMARY AND OBJECTS OF THE INVENTION

The disclosure comprises an automated system for validating, processing, and delivering media content and supporting items, including video, audio, subtitles, artwork, and metadata. The system validates incoming content against predefined specifications, performs transcoding and file conversion as needed, and packages the content for delivery to any endpoint. Using profiles/templates, the system ensures compliance with technical and qualitative requirements. The system operates in the cloud, allowing for scalable and distributed workflows with optional human oversight for nuanced decision-making.

Other features and advantages of the present invention will be apparent from the accompanying drawings and from the detailed description that follows.

### DESCRIPTION OF THE PREFERRED EMBODIMENTS

In the following description, for purposes of explanation, numerous specific details are set forth in order to provide an understanding of the present invention. It will be evident, however, to one skilled in the art that the present invention may be practiced without certain specific details. In other instances, well-known structures and devices are shown in block diagram form to facilitate explanation. The description of preferred embodiments is not intended to limit the scope of the claims appended hereto. In addition, future and present alternatives and modifications to the preferred embodiments described below are contemplated. Any alternatives or modifications which make insubstantial changes in function, in purpose, in structure, or in result are intended to be covered by the claims of this patent.

The presently disclosed system and method includes a series of steps or modules for the workflow process including the following:

### 1. Automated Content Ingest

The system ingests media content and supporting items through APIs, watch folders, or direct file uploads. The system supports both bulk and single-file ingestion, enabling scalability for high-volume operations.

### 2. Validation Mechanisms

File Verification: Ensures all uploaded files meet predefined specifications, including naming conventions, file formats, and sizes.
Metadata Validation: Validates metadata fields against required standards.
QC Checks: Identifies issues with resolution, frame rate, codec, bit rate, or other technical parameters. Detailed error reports are generated for review.

### 3. Processing and Transformation

Transcoding and File Conversion: The system automatically processes media files to meet the required formats, resolutions, and codecs specified in the destination profile.
Automated Error Correction: Applies corrective actions such as file renaming, resizing, and format adjustments to ensure compatibility.

### 4. Profile-Based Configuration

Saved Profiles/Templates: The system uses predefined profiles or templates to dictate the processing, validation, and packaging requirements for each endpoint.
Dynamic Processing: The system adapts processing tasks (e.g., transcoding, file conversion) based on the specifications saved in the profiles.

### 5. Packaging and Delivery

Packaging: Combines validated media content with supporting items (e.g., metadata, artwork) into a cohesive package that meets the endpoint's requirements.
Delivery: The packaged content is delivered to any endpoint, such as streaming services, broadcasters, or other platforms, via secure upload, API integration, or direct download.

### 6. Human Oversight (Optional)

The system flags specific issues or decisions requiring manual review. Users can interact with The system through an intuitive graphical user interface (GUI) to validate or override automated processes.

### 7. Playback and Review

Integrated Playback: Provides a secure media player for reviewing processed content, ensuring quality before delivery.

### 8. Cloud-Based Functionality

The system operates entirely in the cloud, enabling distributed workflows, global accessibility, and scalability.

The advantages of the use of the modules and steps disclosed above include:
Flexibility: Processes media content for any endpoint without limiting to specific destinations, ensuring broad applicability.
Automation: Validates, processes, and delivers content with minimal manual intervention.
Scalability: Cloud-based architecture supports high-volume workflows.
Precision: Ensures compliance with diverse specifications through profile-based processing.
Efficiency: Reduces operational costs and errors through automation.

What is claimed is:

1. An automated system for validating, processing, and delivering media content, comprising:
Automated ingestion of media content and supporting items through APIs, watch folders, or direct uploads.
Validation mechanisms for ensuring compliance with specifications, including file formats, metadata, naming conventions, and quality standards.
Automated processing of media files, including transcoding, file conversion, and error correction, based on predefined profiles/templates.
Packaging of validated media content and supporting items into a cohesive package for delivery to endpoints.
Delivery of processed packages to any endpoint via secure upload, API integration, or direct download.

2. The system of claim 1, wherein the validation mechanisms generate detailed quality control reports and apply automated error correction.

3. The system of claim 1, wherein the profiles/templates specify processing requirements for media formats, resolutions, codecs, metadata, and packaging.

4. The system of claim 1, wherein the processing includes transcoding and file conversion to meet platform specifications.

5. The system of claim 1, wherein the delivery supports secure uploads, API integration, and direct downloads.

6. The system of claim 1, wherein an optional human review interface allows users to validate or override automated processes.

7. The system of claim 1, wherein the system operates entirely in the cloud for scalability and distributed workflows.
